(19) United States
(12) Patent Application Publication
(10) Pub. No.: US 2012/0011393 A1
(43) Pub. Date: Jan. 12, 2012

(54) BIOS RECOVERY

(76) Inventors: Richard B. ROBERTS, Colorado Springs, CO (US); David A. Daigle, Colorado Springs, CO (US); Peter L. McCollum, Colorado Springs, CO (US)

(21) Appl. No.: 12/831,042

(22) Filed: Jul. 6, 2010

(51) Int. Cl. G06F 11/08; G06F 12/06

(52) U.S. Cl. 714/6.3; 711/102; 714/E11.03; 711/E12.078; 713/2

(57) ABSTRACT

Techniques for basic input output system (“BIOS”) recovery are disclosed herein. In one embodiment, a BIOS recovery system includes a processor and two non-volatile storage devices configured for contiguous addressing. The devices are configured to include a first BIOS storage region disposed at an upper end of a higher addressed of the storage devices, and to include a platform data region of capacity equal to a configured capacity of each of the storage devices. The platform data region is disposed to include part of each of the two storage devices, and includes a second BIOS storage region, equal in capacity to the first BIOS storage region, disposed in the lower addressed of the storage devices. The first BIOS storage region is accessible for retrieval of a BIOS for execution and the second BIOS storage region is not accessible for retrieval of a BIOS for execution.

### BACKGROUND

A computer-based device may include basic input output system (“BIOS”) programming. A processor in the device executes the BIOS programming to identify and test device hardware at startup, and to load and initiate an operating system, to interface with peripheral devices, etc.

The BIOS is generally stored in non-volatile semiconductor memory to allow for quick startup of the computer-based device. BIOS storage may feature in system reprogrammability to facilitate updating of BIOS programming. If the BIOS is corrupted, for example, if the stored BIOS programming is incorrect or damaged, then the device may be unable to boot.

### BRIEF DESCRIPTION OF THE DRAWINGS

For a detailed description of exemplary embodiments of the invention, reference will now be made to the accompanying drawings in which:

FIG. 1 shows a block diagram of a computer-based device including BIOS recovery in accordance with various embodiments;

FIG. 2 shows a diagram of BIOS storage configured to provide BIOS recovery in accordance with various embodiments;

FIG. 3 shows a block diagram of selection logic configured to route select signals to BIOS storage devices in accordance with various embodiments; and

FIG. 4 shows a flow diagram for a method for BIOS recovery in accordance with various embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect, direct, optical or wireless electrical connection. Thus, if a first device couples to a second device, that connection may be through a direct electrical connection, through an indirect electrical connection via other devices and connections, through an optical electrical connection, or through a wireless electrical connection. Further, the term “software” includes any executable code capable of running on a processor, regardless of the media used to store the software. Thus, code stored in memory (e.g., non-volatile memory), and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various computer-based devices store a basic input output system (“BIOS”) and associated programming and data in one or more non-volatile storage devices (e.g., FLASH memory devices) that are erasable and writeable in the device. Use of such storage facilitates introduction of new and/or different versions of the programming and data to the device. While generally robust, non-volatile storage devices are subject to corruption caused by a variety of internal and external conditions. For example, power instability while in the process of reprogramming may result in corruption or loss of data in the storage device. The device may be unable to startup properly if the BIOS or associated structures are damaged.

To mitigate the effects of a corrupted BIOS or associated data/programming stored in non-volatile memory, multiple copies of the BIOS may be stored. If device startup based on a given copy of the BIOS fails, a selection mechanism may cause the device to reattempt startup using a different copy of the BIOS.

BIOS programming is configured for operation with specific hardware, for example, a specific processor or processor type and specific logic (e.g., logic embodied in a chipset) configured for operation with an attached processor and associated device (e.g., memory, peripherals, etc). Some chipsets are configured to manage attached BIOS storage in a way that prohibits reprogramming of various regions of the non-volatile storage. Consequently, if such a non-writable region is corrupted or requires updating, the storage device cannot be reprogrammed in system.

Embodiments of the present disclosure include non-volatile storage configured to allow all regions of the storage to be reprogrammed in system when using a chipset configured to prohibit in system reprogramming of some regions of the storage.

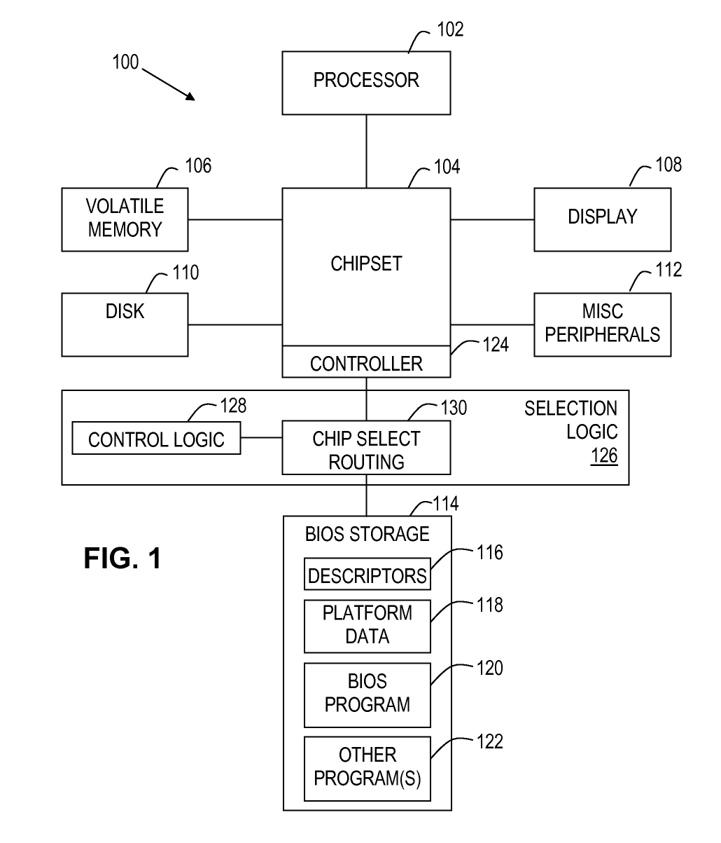

FIG. 1 shows a block diagram of a computer-based device 100 including BIOS recovery in accordance with various embodiments. The computer-based device may be a desktop computer, a laptop or other portable computer, a server, a router or other networking device, etc. The device 100 includes a processor 102, a chipset 104, BIOS storage 114, and various other devices and systems accessible by the processor 102 via the chipset 104.

The processor 102 may be a general-purpose processor, such as a processor produced by Intel Corporation, or a special-purpose processor such as a digital signal processor, a microcontroller, etc. Embodiments of the processor 102 generally include execution units (e.g., integer, fixed point, floating point, etc.), storage (e.g., registers, memory, etc.), instruction decoding and/or scheduling logic, clock systems, and interconnect systems (e.g., buses). The processor 102 executes instructions fetched from a memory or other computer-readable medium.

The chipset 104 provides an interface between the processor 102 and various peripheral systems and devices. In some embodiments, the chipset 104 may include a northbridge and a southbridge. Embodiments of the chipset 104 may implement the northbridge and southbridge as separate components or as a single component. Some embodiments may combine the processor 102 and the chipset 104 into a single component.

The volatile memory 106 may be, for example, dynamic random access memory (e.g., DRAM, DDRAM, SDRAM, etc), static random access memory, or the equivalent. The volatile memory 106 may be interfaced to the processor 102 via a memory controller of the chipset 104 as shown, or, in embodiments of the processor 102 including a memory controller, may be interfaced directly to the processor 102.

Disk 110 provides storage for program and data elements apart from the BIOS Storage 114. Disk 110 typically comprises a magnetic hard drive, but more generally may comprise a FLASH drive, optical drive, or other non-volatile storage medium.

Display 108 provides visual information to a user. A Liquid Crystal Display, Cathode Ray Tube display, plasma display, Organic Light Emitting Diode display, electroluminescent display, projection display, or other display technology suitable for displaying text and/or graphics may be employed.

The miscellaneous peripherals 112 include input/output devices (e.g., keyboard, mouse, trackball, touchpad, touchscreen, etc), audio transducers (e.g., microphone, speakers), network interfaces, etc. The chipset 104 may include interfaces dedicated to a peripheral (e.g., audio input/output), and/or general-purpose interfaces (e.g., universal serial bus, peripheral component interface, etc) for connecting with the peripherals 112.

The chipset 104 may include a controller 124 that manages access to the BIOS storage 114. The controller 124 may be configured to prohibit write accesses to various regions of the BIOS storage 114, and to allow write accesses to other regions. In some embodiments, the controller 124 is implemented as processor, similar to the processor 102, that executes software programming.

The BIOS storage 114 provides non-volatile memory for storing programs and data. In some embodiments, a BIOS program 120 used to boot the device 120, device 120 configuration descriptors 116, other programs (e.g., programming executed by the controller 124), and/or platform data 118 reserved for general information use are included in the BIOS storage 114. In some embodiments, the BIOS storage 114 may be interfaced to the chipset 104 via a Serial Peripheral Interface Bus (“SPI”).

In some devices, the controller 124 restricts descriptor 116 accesses to read accesses only. Embodiments of the present disclosure advantageously allow descriptors 116 to be written by the processor 102 even though the controller 124 restricts descriptor 116 accesses to reading. Embodiments provide this advantage along with redundancy for descriptors 116, BIOS Program 120, and other programs 122 by configuration of the platform data 118 as described herein, and by inclusion of the selection logic 126. The selection logic 126 includes chip select routing 130 and control logic 128, and provides control of BIOS storage selection independently of the controller 124.

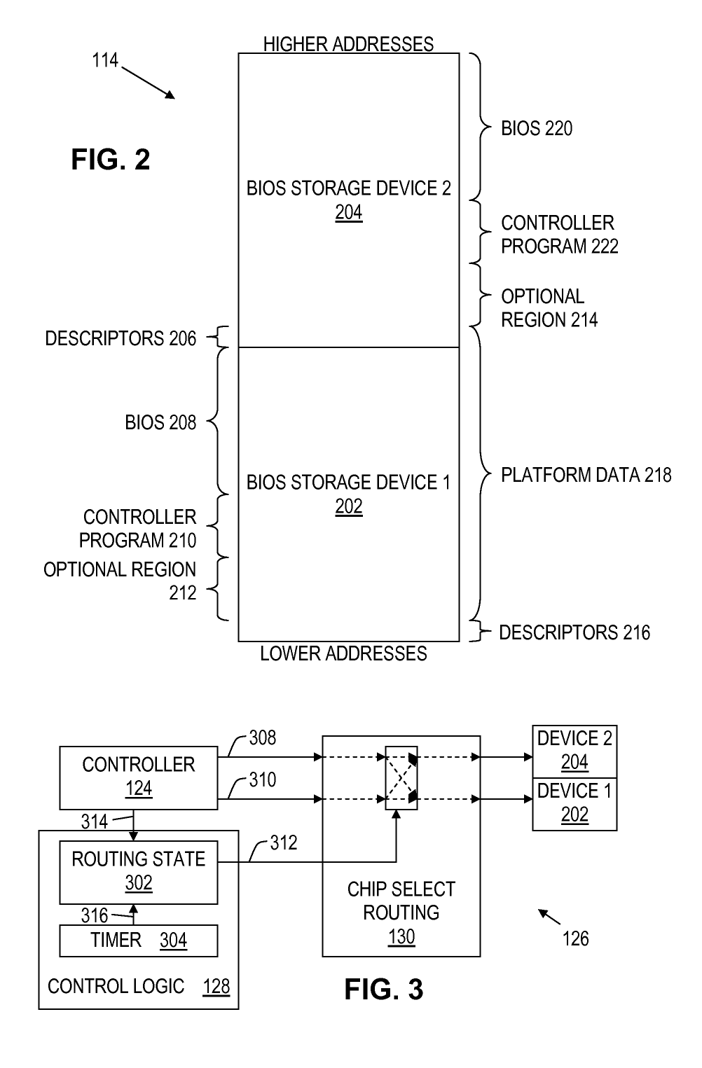

FIG. 2 shows a diagram of BIOS storage 114 configured to provide BIOS recovery in accordance with various embodiments. The BIOS storage 114 includes two non-volatile BIOS storage devices 202, 204. Each of the BIOS storage devices 202, 204 are configured to provide a same given storage capacity. For example, if device 1 202 is configured to provide 4 megabytes (“MB”) of storage capacity, then device 2 204 is also configured to provide 4 MB of storage capacity. The storage capacity of the devices 202, 204 may be determined by, for example, the maximum capacity of the devices 202, 204 or by a configuration parameter defining the useable capacity of each of the devices 202, 204.

In some embodiments, the organization of the storage regions included in the BIOS storage 114 is constrained by use of the chipset 104, wherein the controller 124 is configured for operation based on a predetermined organization of the storage regions 216, 218, 220, 222 in the BIOS storage 114. In some embodiments, the arrangement of regions 216, 218, 220, and 222 is constrained as illustrated in FIG. 2, wherein a descriptors region 216 is disposed beginning at the lowest address of the BIOS storage 114 (e.g., the lowest address of BIOS storage device 1 202), and a BIOS region 220 is disposed to end at the highest address of the BIOS storage 114 (e.g., the highest address of the BIOS storage device 2 204). A platform data region 218 is disposed directly above the descriptors region 216. An optional region 214 and controller program region 222 (e.g., storing other programs 122) are respectively disposed above the platform data region 214. Thus, the combination of the descriptors region 216, the platform data region 218, the optional region 214, the controller program region 216, and the BIOS region 220 may occupy the entirety of the BIOS storage 114. The controller 124 is configured to operate with the regions 216, 218, 214, 222, 220 placed in the sequence shown, with the descriptors region 216 and the BIOS region 220 respectively positioned at the lowest and highest memory addresses of the BIOS storage 114. In some embodiments, lowest 4 kilobytes (“KB”) of the BIOS storage 114 are allocated to the descriptors region 216, and the sizes of the other regions 218, 214, 220, 222 are variable to occupy the remainder of the BIOS storage 114.

Thus, the totality of the BIOS storage 114 is allocated to the illustrated memory regions 216, 218, 214, 222, 220, which may be referred to as the “active” regions. The controller 124 may be configured to operate based on these regions. Thus, the controller 124 may be configured to retrieve a BIOS 120 for execution by the processor 102 from the BIOS region 220 located at the uppermost addresses of the BIOS storage 114. Embodiments of the controller 124 may also bar the processor 102 from writing to the descriptors region 216 (i.e., the descriptors 116 may be read-only).

In order to provide improved device 100 reliability, embodiments of the present disclosure arrange the storage regions 216, 218, 214, 222, 220 across the two BIOS storage devices 202, 204 to provide redundancy for all storage regions and to allow updating of the descriptors 116. Embodiments provide such redundancy by allocating to the platform data region 218 an amount of storage equal to the storage capacity provided for use by each of the BIOS storage devices 202, 204. Thus, if each of device 1 202 and device 2 204 are configured to provide 4 MB of storage, then 4 MB of storage are allocated to the platform data 218 region. Because the platform data region 218 is disposed immediately above the descriptors region 216, the platform data region 218 extends into the BIOS storage device 2 204 for a length equal to the length of descriptors region 216 (e.g., 4 KB). Thus, in embodiments of the present disclosure, the platform data region 218 occupies all but the descriptors 216 region of the BIOS storage device 1 202, and occupies a lowest addressable portion of the BIOS storage device 2 204 of size equal to the descriptors region 216.

The platform data region 218 is subdivided into a number of sub-regions 206-212, which may be referred to as “reserve” regions 206-212. Each reserve region is sized and positioned to provide redundancy for a corresponding active region 216, 214, 222, 220. Thus, the descriptors region 206 provides redundancy for the descriptors 216, the BIOS 208 provides redundancy for the BIOS 220, the controller program 210 provides redundancy for the controller program 222, and the optional region 212 provided redundancy for the optional region 214.

As explained above, the controller 124 may be configured to access a given region only at a specified storage location. For example, the controller 124 may retrieve the BIOS 120 for execution only from the uppermost address space of the BIOS storage 114 (i.e., the BIOS region 220). Consequently, the controller 124 may be unable to retrieve for execution the BIOS 208 because the BIOS 208 is not located at the top of the BIOS storage 114 address space.

Embodiments allow BIOS storage device 1 202 and BIOS storage device 2 204 of switch positions in the BIOS storage 114 address space. By switching the address positions of the devices 202 and 204, a BIOS program 120 previously positioned in the BIOS region 208 is repositioned at the top the BIOS storage 114 address space, and the descriptors 116 previously positioned in the descriptor region 206 are repositioned at the bottom the BIOS storage 114 address space. That is, the data previously positioned in reserve regions 206-212 will respectively occupy the address spaces assigned to the active regions 216, 220, 222, and 214, and the data previously disposed in the active regions 216, 220, 222, and 214 will be repositioned in the address space reserved for the reserve regions 206-212. Explained in a alternative manner, the storage regions 206-222 may be viewed as static address ranges, and information stored in device 1 202 and device 2 204 change locations across the address ranges when the address positions of the devices 202 and 204 are swapped.

Thus, embodiments provide redundancy for all regions of the BIOS storage 114, and allow the processor 102 to write the descriptors 116 by writing to corresponding fields of the descriptors region 206, which will be positioned at the lowermost addresses of the BIOS storage 114 after the devices 202 and 204 are swapped in the address space.

FIG. 3 shows a block diagram of selection logic 126 configured to route select signals to BIOS storage devices 202, 204 in accordance with various embodiments. The selection logic 126 switches the position of the devices 202, 204 in the BIOS storage 114 address space, thereby swapping the positions of data in active and reserve regions. The selection logic 126 includes chip select routing logic 130 and control logic 128. The chip select routing logic 130 routes one of chip selects 308, 310 generated from the controller 124 to each of the BIOS storage devices 202, 204.

The control logic 128 includes routing state logic 302 and timer 304. Routing state logic 302 controls which of the chip selects 308, 310 is routed to each device 202, 204. In a first state (e.g., state “0”), assertion of the chip select 308 may activate device 1 202, and assertion of the chip select 310 may activate device 2 204. Conversely, in a second state (e.g., state “1”), assertion of the chip select 310 may activate device 1 202, and assertion of the chip select 308 may activate device 2 204.

The routing state logic 302 is driven by signals provided from the controller 124 and the timer 304. The timer 304 may be watchdog timer configured to change the routing state if the timer 304 expires before the processor 102 properly executes a retrieved BIOS 120 (e.g., before the processor 102 properly completes BIOS 120 execution and starts an operating system). In some embodiments, the routing state logic is a flip-flop and input data and clock (both data and clock shown as signal 316) for the flip-flop are provided by the timer 304. The timer 304 provides the clock and data signals 316 to toggle the state value responsive to the timer 304 expiring. In some embodiments, the controller 124 provides an enable signal 314 allowing the routing state to change only when the processor 102 is in a reset state. In some embodiments, the timer 304 may be implemented as an auxiliary processor or board management device and may include logic allowing the chip select routing state to be changed based on a command or trigger signal received from the processor 102.

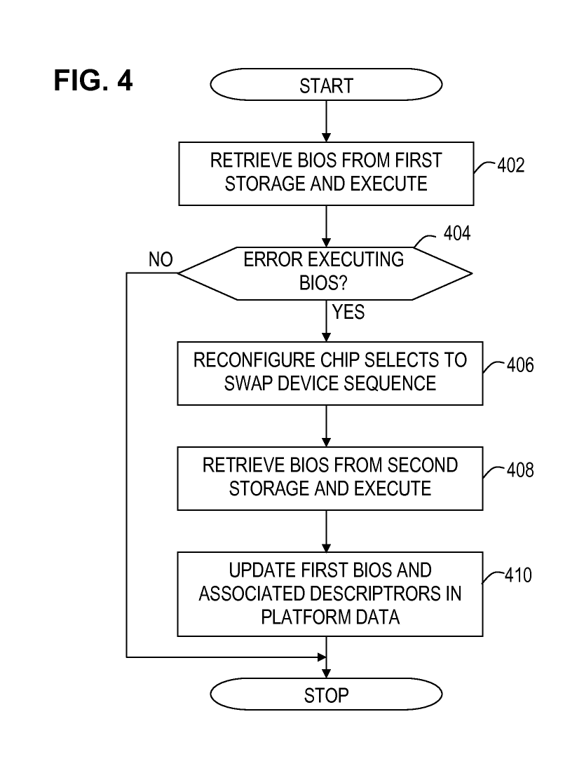

FIG. 4 shows a flow diagram for a method for BIOS recovery in accordance with various embodiments. Though depicted sequentially as a matter of convenience, at least some of the actions shown can be performed in a different order and/or performed in parallel. Additionally, some embodiments may perform only some of the actions shown. In some embodiments, the operations of FIG. 4, as well as other operations described herein, can be implemented as instructions stored in a computer readable medium and executed by a processor (e.g., processor 102 or controller 124) in conjunction with various other components (e.g., control logic 128, chip select routing 130, etc.).

In block 402, the device 100 is operating and the selection logic 126 is configured to route chip selects 308, 310 provided from the controller 124 to the BIOS storage devices 202, 204. Based on the chip select routing state, the controller 124 retrieves a first BIOS for execution by the processor 102. The BIOS retrieved for execution is located in the BIOS region 220 disposed at the uppermost addresses of the BIOS storage 114. In some embodiments, the BIOS retrieved from the BIOS storage 114 is moved to the volatile memory 106 for execution by the processor 102.

In block 404, the device 100 determines whether an error has occurred during BIOS execution. For example, a check value (e.g., a cyclic redundancy check) associated with the retrieved BIOS may indicate that the BIOS is corrupt, the timer 304 may time out awaiting a timer reset from the processor 102 indicating successful BIOS execution, etc. If BIOS execution is successful, method is complete.

If BIOS execution is unsuccessful, then in block 406 the chip select routing logic 130 is reconfigured to swap the positions of the BIOS storage devices 202, 204 in the BIOS storage 114 address space. The reconfiguration is related to a change in routing state 302 that may be in response to signals provided from the timer 304 after the timer 304 expires. The chip select routing logic 130 reconfiguration swaps the destinations of the chip select signals 308, 310 provided from the controller 124, thereby causing the controller 124 to fetch a different instance of the BIOS for execution by the processor 102 during the next BIOS retrieval.

In block 408, a device 100 reset is performed and the controller 124 retrieves from BIOS storage 114 a second BIOS for execution. The second BIOS retrieved in block 408 may different from the first BIOS retrieved in block 402, and may be a BIOS that was disposed in the BIOS region 208 prior to swapping the destinations of the chip select signals. In some embodiments, the controller 124 moves the second BIOS into the volatile memory 106 from where the processor 102 fetches and executes the instructions of the second BIOS.

In block 410, the processor 102 writes BIOS instructions (e.g., updated BIOS) to the BIOS storage region 208 disposed in the platform data 218. Information overwritten in the BIOS storage region 208 was located in the BIOS storage region 220 prior to reconfiguring the chip selects. The processor 102 may also write descriptor data to the descriptor region 206 disposed in the platform data 118, and/or may write data to the regions 210 and/or 212. The BIOS and descriptors disposed in the platform data region 218 will become the active BIOS and descriptors following a next reconfiguration of the chip selects via a subsequent change in state of the routing state logic 302.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A basic input output system (“BIOS”) recovery system, comprising:
a processor configured to execute a BIOS retrieved from non-volatile storage; and
two non-volatile storage devices configured for contiguous addressing;
wherein the storage devices are configured to include:
a first BIOS storage region disposed at an upper end of a higher addressed of the storage devices;
a platform data region, of capacity equal to a configured capacity of each of the storage devices, disposed to include an upper portion of a lower addressed of the storage devices and a lower portion of the higher addressed of the storage devices, the platform data region comprising a second BIOS storage region disposed in the lower addressed of the storage devices, and equal in capacity to the first BIOS storage region;
wherein the first BIOS storage region is accessible for retrieval of a BIOS for execution and the second BIOS storage region is not accessible for retrieval of a BIOS for execution.

2. The BIOS recovery system of claim 1, further comprising a controller configured to access the storage devices and to retrieve a BIOS for execution only from the first BIOS storage region.

3. The BIOS recovery system of claim 1, further comprising selection logic configured to swap chip select signals provided to the pair of storage devices, thereby swapping the upper and lower devices

4. The BIOS recovery system of claim 1, wherein the storage devices are further configured to include a region of the upper of the storage devices dedicated to storage of a program executed by the controller, and the platform data region further comprises a region disposed in the lower of the storage devices dedicated to storage of a program executed by the controller, and wherein the controller is configured to retrieve and execute only the program stored in the upper of the storage devices.

5. The BIOS recovery system of claim 1, wherein the storage devices are further configured to include a descriptor region disposed at a lower end of the lower of the storage devices and the platform data region further comprises a descriptor region disposed at a lower end of the upper of the storage devices; and
of the descriptor regions, the controller is configured to write only the descriptor region of the platform data.

6. The BIOS recovery system of claim 5, wherein the descriptor region disposed at a lower end of the lower of the storage devices is mutable by modifying the descriptor region of the platform data and causing selection logic to swap the address ranges at which the storage devices are accessed.

7. A method, comprising:
detecting, by basic input output system (“BIOS”) selection circuitry, a failure to execute a first BIOS retrieved from a first non-volatile storage device;
reconfiguring, by the selection circuitry, select signals applied to the first non-volatile storage device and a second non-volatile storage device responsive to the detecting;
causing, responsive to the reconfiguring, the second non-volatile storage device to appear at addresses used to access the first non-volatile storage device prior to the reconfiguring, and the first device to appear at addresses previously used to access the second device prior to the reconfiguring;
accessing a different BIOS stored in the second non-volatile storage device responsive to the reconfiguring;
wherein addresses used to access the different BIOS after the reconfiguring are the same as addresses used to access the first BIOS prior to the reconfiguring, and prior to the reconfiguring the different BIOS is stored in a platform data region of the second non-volatile storage device.

8. The method of claim 7, wherein the accessible capacities of the first non-volatile storage device, the second non-volatile storage device, and the platform data region are equal.

9. The method of claim 7, wherein the platform data region occupies an upper portion of the first non-volatile storage device and a lower portion of the second non-volatile storage device.

10. The method of claim 7, wherein a top portion of the platform data region includes descriptor fields identical to descriptor fields located at a lower portion of the first non-volatile storage device.

11. The method of claim 7, wherein the platform data region occupies all but the descriptor region of the first non-volatile storage device.

12. The method of claim 7, further comprising writing an updated BIOS to a portion of the platform data region disposed wholly in the first non-volatile storage device.

13. The method of claim 7, further comprising writing descriptor field values to a portion of the platform data region disposed in the second non-volatile storage device while prohibited from writing descriptor field values to the first non-volatile device.

14. A computing device, comprising:
a first non-volatile storage device;
a second non-volatile storage device;
a first data region accessible at a lowest address of the first device;
a second data region addressable immediately above the first data region, the second data region having storage capacity equal to the first device; and
a third data region addressable above the second data region in the second device and extending to a highest address of the second device; and
a processor configured to execute a basic input output system retrieved from the third data region;
wherein the second data region comprises:
a first sub-data region accessible at a lowest address of the second device, and equal in size to the first data region; and
a second sub-data region addressable in the first device and extending to the highest address of the first device;
wherein the first and second non-volatile storage devices are configured for contiguous addressing.

15. The computing device of claim 14, wherein the third data region and the second sub-data region are of equal capacity, and are positioned at identical locations in the first and second devices.

16. The computing device of claim 14, further comprising a controller configured to prohibit writing of the first data region.

17. The computing device of claim 14, wherein each of the second sub-data region and the third data region include a copy of a basic input output system (“BIOS”), and only the third data region is accessible for retrieval of a copy of the BIOS for execution.

18. The computing device of claim 14, further including selection logic configured to selectably swap the address locations used to access the first device and the second device.

19. The computing system of claim 18, wherein the selection logic is configured to swap the address locations based on the computing device failing to properly execute a BIOS.

20. The computing system of claim 14, wherein the first sub-data region and the first data region include identical data fields, and the values stored in the fields of the first data region are modifiable via the first sub-data region.
